(19) United States
(12) Patent Application Publication
(10) Pub. No.: US 2011/0099088 A1
(43) Pub. Date: Apr. 28, 2011

(54) VARIOUS METHODS AND APPARATUSES FOR COMPLETING A TRANSACTION ORDER THROUGH AN ORDER PROXY SYSTEM

(75) Inventors: JESUS MANNY BERRIOS, SAUSALITO, CA (US); HENRY WONG, SAUSALITO, CA (US); JOHN UNDERWOOD, MILL VALLEY, CA (US)

(73) Assignee: ADGREGATE MARKETS, INC., SAN FRANCISCO, CA (US)

(21) Appl. No.: 12/913,573

(22) Filed: Oct. 27, 2010

Related U.S. Application Data
(60) Provisional application No. 61/255,683, filed on Oct. 28, 2009.

(51) Int. Cl. G06Q 30/00

(52) U.S. Cl. 705/26.81; 705/27.1

(57) ABSTRACT

A method, apparatus, and system for an order proxy are provided. In an embodiment, an example order proxy system implemented in software, hardware logic, or a combination of both, may be configured to allow an e-commerce digital shopping cart to submit and complete transaction orders. An embodiment uses various necessary information and steps for completing a transaction into an e-commerce system without there being any prior software integration between fields and transaction processing steps coded into the shopping cart. A first commerce system may complete a transaction order through the order proxy system. Additionally, the order proxy system may have a merchant cart configuration map module to map the shopping cart information into a merchant server's shopping cart process.

### RELATED APPLICATIONS

This application claims the benefit of U.S. Provisional Patent Application Ser. No. 61/255,683, filed Oct. 28, 2009 and entitled “VARIOUS METHODS AND APPARATUSES FOR COMPLETING A TRANSACTION ORDER THROUGH AN ORDER PROXY SYSTEM.”

### NOTICE OF COPYRIGHT

A portion of the disclosure of this patent document contains material that is subject to copyright protection. The copyright owner has no objection to the facsimile reproduction by anyone of any software and its modules as it appears in the Patent and Trademark Office Patent file or records, but otherwise reserves all copyright rights whatsoever.

### BACKGROUND

The Internet is a global system of interconnected computer networks. These networks generally use the Internet Protocol Suite (TCP/IP) and serve many users. The Internet may be described as a network of networks. As such is may include millions of networks. These networks that make up the Internet can include private, public, academic, business, and government networks. Additionally, these sub-networks may be anywhere from local to global in scope.

The networks that make up the Internet may be linked by a broad array of communication technologies which can be used to transmit and receive many types of information resources and services. In some cases, the Internet may be used to transmit and receive various commercial transactions.

An e-commerce shopping cart should properly transmit transaction orders by communicating with the corresponding commerce system.

### SUMMARY OF THE INVENTION

Various methods and apparatus include an order proxy system are provided. In an embodiment, an example order proxy system implemented in software, hardware logic, or a combination of both, may be configured to allow an e-commerce digital shopping cart to submit and complete transaction orders. An embodiment uses various necessary information and steps for completing a transaction into an e-commerce system without there being any prior software integration between fields and transaction processing steps coded into the shopping cart. A first commerce system may complete a transaction order through the order proxy system. Additionally, the order proxy system may have a merchant cart configuration map module to map the shopping cart information into a merchant server's shopping cart process.

### BRIEF DESCRIPTION OF THE DRAWINGS

The drawings refer to embodiments of the invention in which:

FIG. 1 illustrates a block diagram of an example computer system that may use an embodiment of one or more of the software applications discussed herein.

FIG. 2 illustrates a network environment in which the techniques described may be applied.

FIG. 3 illustrates a block diagram of an example order handling process.

FIG. 4 illustrates a block diagram of an example order proxy process.

FIG. 5 illustrates an example method in accordance with an embodiment.

FIG. 6 illustrates another example method in accordance with another embodiment.

While the invention is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the invention.

### DETAILED DISCUSSION

In the following description, numerous specific details are set forth, such as examples of specific routines, named components, connections, Internet publishing and advertising technology, etc., in order to provide a thorough understanding of the present invention. It will be apparent, however, to one skilled in the art that the present invention may be practiced without these specific details. In other instances, well known components or methods have not been described in detail but rather in a block diagram in order to avoid unnecessarily obscuring the present invention. Thus, the specific details set forth are merely exemplary. The specific details may be varied from and still be contemplated to be within the spirit and scope of the present invention.

Various methods and apparatus including an order proxy system are provided. In an embodiment, an example an order proxy system may be implemented in a client-server system. Such a system can be configured to allow an e-commerce digital shopping cart, supplied from (1) a first server which hosts a first e-commerce website or from (2) a third party server that is not hosting the first e-commerce website, such a server directly providing the proxy service or even a server from another e-commerce website. One of these servers may submit and complete transaction orders with any necessary information and steps for completing a first transaction into the first e-commerce system hosted on the first server without there being any prior software integration between fields and transaction processing steps coded into the digital shopping cart and the first e-commerce system. A first transaction order may be completed through the order proxy system, where the order proxy system has a merchant cart configuration map module to map the shopping cart information into a merchant server's shopping cart process of two or more e-commerce systems. Additionally, the same digital shopping cart can be configured to submit and complete transaction orders with any necessary information and steps for completing a second transaction into a second e-commerce system hosted on a second server. The second transaction order may be completed through the order proxy system, without there being any prior software integration between fields and transaction processing steps between the digital shopping cart and the second e-commerce system. Thus, the same universal shopping cart can be used on hundreds, thousands, etc. different e-commerce sites.

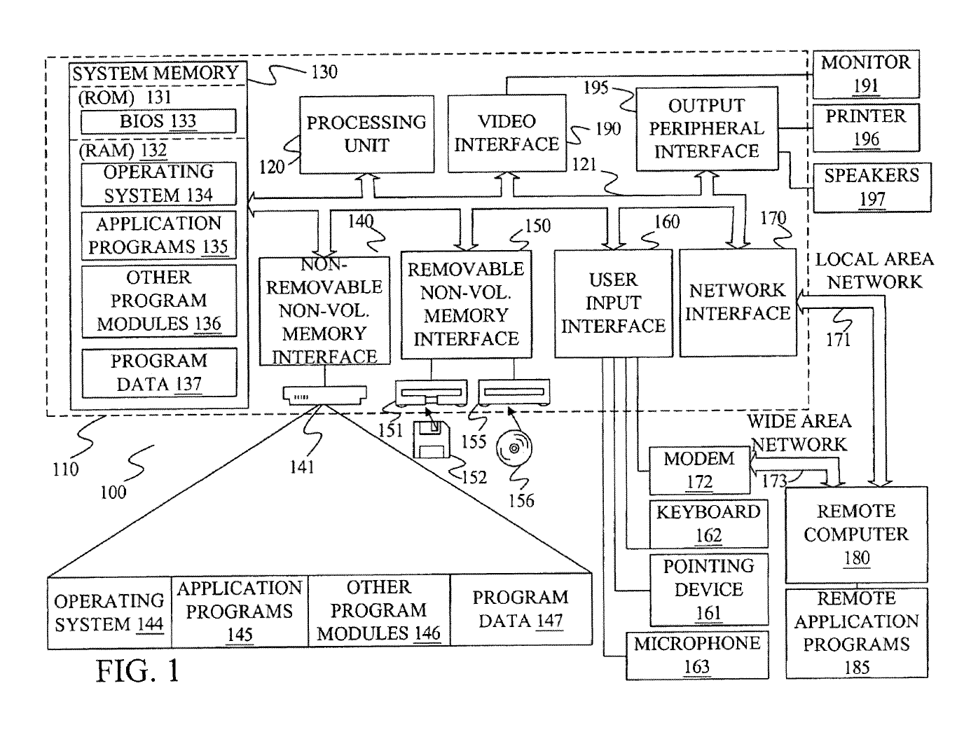

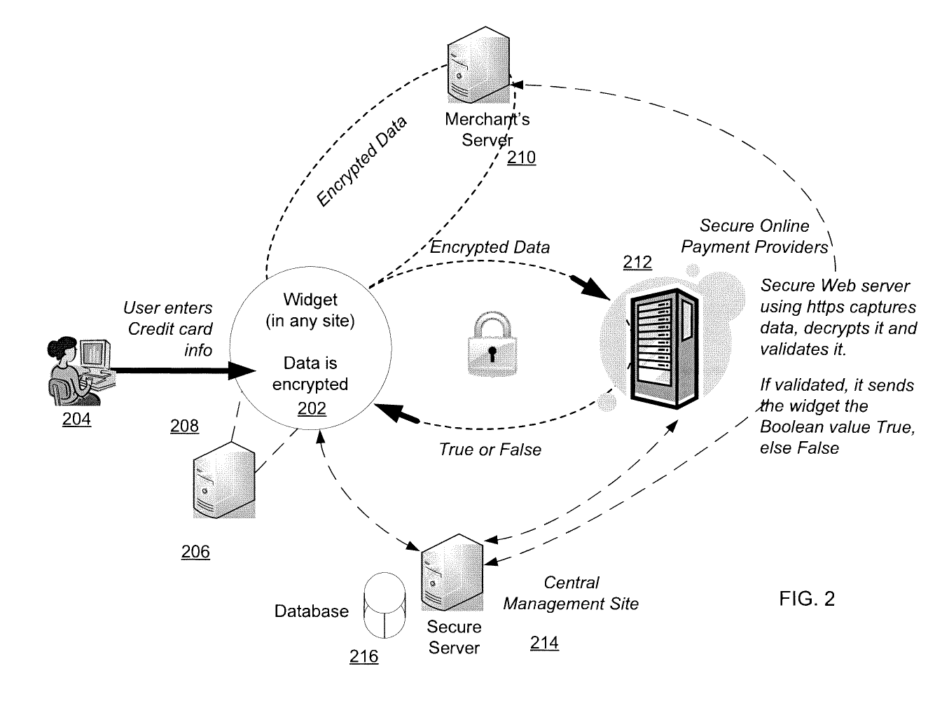

An embodiment relates to a system and method for completing a transaction order through an order proxy system. However, prior to discussing any embodiments in greater detail, one illustrative environment in which example embodiments can be used will be discussed in FIGS. 1 and 2.

FIG. 1 illustrates a computing device 110, such as a computer, PDA, iPhone, etc. with a resident browser application in which the techniques described may be applied. More details are described below.

FIG. 2 illustrates a network environment 200 in which the techniques described may be applied. The network environment 200 has a network 202 that connects S number of servers 204-1 through 204-S, and C number of clients 208-1 through 208-C. More details are described below.

The order proxy system enables any e-commerce shopping cart to submit and complete transaction orders into any commerce system without there being any prior integration between such shopping cart and such commerce system.

For an e-commerce shopping cart to properly transmit transaction orders it must be able to communicate with the corresponding commerce system in order to complete the necessary steps for completing the transactions, which may include receiving product information (such as price and available quantity), transmitting consumer information (such as name and address), authenticating or registering the user, transmitting payment information, and receiving confirmation or rejection of payment completion. This communication is currently completed via various methods of software integration (such as the use of application programming interfaces). By routing a transaction order through an order proxy system, an embodiment enables such communication without any form of software integration between the e-commerce shopping cart and the e-commerce system.

An embodiment can enable an e-commerce shopping cart to communicate with a commerce system without software integration. Eliminating such integration would enable the rapid deployment of e-commerce shopping carts compatible with any commerce system.

An embodiment may be implemented in e-commerce digital shopping carts that could be deployed on websites, rich media advertisements, Internet-connected applications, and mobile applications. An embodiment can enable any merchant to more quickly deploy such shopping carts by eliminating direct software integration. Shopping cart software is software used in e-commerce to assist people making purchases online. The Shopping cart software allows online shopping customers to accumulate a list of items for purchase, described metaphorically as “placing items in the shopping cart”. Upon checkout, the software typically calculates a total for the order, including shipping and handling (i.e. postage and packing) charges and the associated taxes, as applicable.

The use of an order proxy system eliminates any software integration, unlike the current method for integrating e-commerce shopping carts with commerce systems, which requires software integration.

Use of an order proxy system results in no change to the functions of the e-commerce system (order processing, etc.), but eliminates the need for software integration between the shopping cart and commerce system.

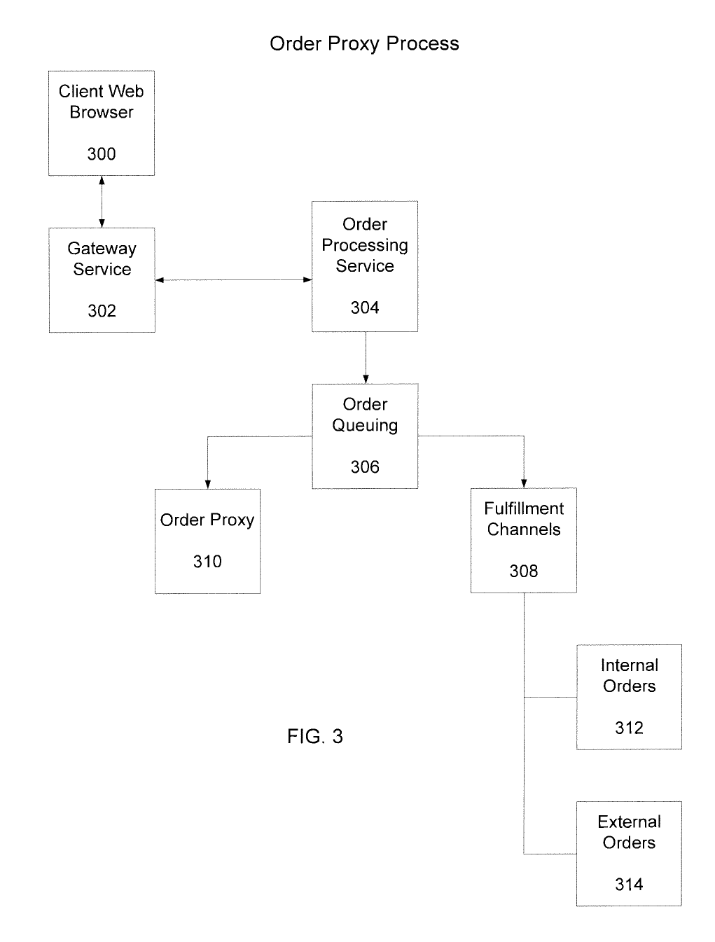

FIG. 3 illustrates a block diagram of an example order handling process. The example of FIG. 3, illustrates how a transaction order can be routed from a client web browser into an order processing system, where the order proxy process is one processing option.

A user initiates transaction order from a client web browser 300. This can allow a user to initiate a transaction from many different types of web capable devices. For example, a user may initiate a transaction from a personal computer connected to the Internet or a web based mobile device, such as a mobile phone, smart phone, computing pad device, or other web based devices.

A client web browser 300 passes an order into the order handling system, which passes the order through a gateway service 302, an order processing service 304, and into an order queuing service 306. An embodiment may include a database with a library of retailer maps. A gateway service receives inbound shopping cart communications and directs them to order processing service 304. Additionally, an order proxy block does all the mapping and injecting of data and fulfillment of business logic steps.

The order processing service determines whether the order can be fulfilled directly through a fulfillment channel 308 or must be fulfilled using an order proxy system 310. Additionally, a web browser ordering experience may be simulated. For example, partners using the order proxy service that have integrated their system with the order proxy service and the data extracted from the shopping cart are directly injected into their ordering system in one injection step.

In an embodiment, an order proxy system implemented in a client-server system, configured to allow an e-commerce digital shopping cart, supplied from (1) a first server which hosts a first e-commerce website or from (2) a third party server that is not hosting the first e-commerce website. Additionally, the same digital shopping cart might be configured to submit and complete transaction orders with any necessary information and steps for completing a second transaction into a second e-commerce system hosted on a second server. This may be completing through the order proxy system, without there being any prior software integration between fields and transaction processing steps between the digital shopping cart and the second e-commerce system.

An order proxy system 310 implemented in software, hardware logic, or a combination of both, may be configured to allow an e-commerce digital shopping cart to submit and complete transaction orders with necessary information and steps for completing a transaction into an e-commerce system. In an embodiment this might be accomplished without there being any prior software integration between fields and transaction processing steps coded into the shopping cart and a first commerce system. For example, a transaction order may be completed through the order proxy system 310, where the order proxy system 310 has a merchant cart configuration map module to map the shopping cart information into a merchant server's shopping cart process. Additionally, in an embodiment a fulfillment channel 308 can use internal orders 312 and external orders 314.

In an embodiment, the proxy system 310 may be a middle man for a universal standard shopping cart that has a library of mapped out online shopping process for an e-commerce merchant. The proxy system can extract information from the shopping cart and stands in as a proxy during a simulative web browsing experience as the proxy system injects data into the fields to populate those fields of an e-commerce ordering process. This can give any necessary responses to advance an order process and relays notices to a user on the client machine filling out the shopping cart.

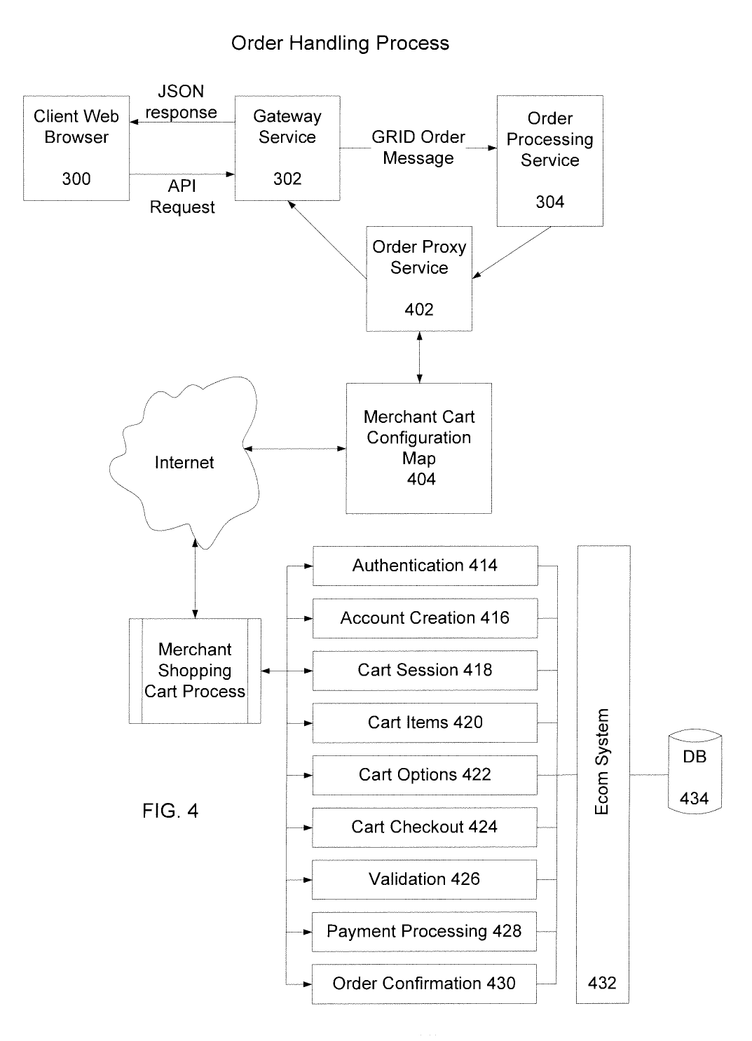

FIG. 4 illustrates a block diagram of an example order proxy process. Once an order is submitted into the order proxy system, the system communicates through the Internet 410 with the merchant's shopping cart 412 in order to map the merchant's shopping cart configuration. This mapping process can include all steps related to the transaction, including authentication 414, account creation 416, cart session 418, cart items 420, cart options 422, cart checkout 424, validation 426, payment process 428, and order confirmation 430.

After mapping the shopping cart information to the merchant's shopping cart configuration, the order proxy system is then able to transmit the order through the merchant's shopping cart process 406 and into the merchant's e-commerce system 432 and database 434. The transmission of an order through the order proxy system can result in two-way communication with the merchant's e-commerce system and the proxy system and the proxy system and the client machine running the client web browser 300. In an embodiment, an order rejection or confirmation response from the merchant's e-commerce system can be routed through the order proxy system to be displayed to the user who originated the order in the client web browser 300. The above steps may be added to and modified in the spirit of the design.

In an embodiment, an order proxy system may include an e-commerce digital shopping cart. The shopping cart can be used to submit and complete transaction orders with necessary information and steps for completing a transaction into an e-commerce system without there being any prior software integration between fields. Additionally, transaction processing steps can be coded into the shopping cart and a first commerce system, via completing a transaction order through the order proxy system. An embodiment can include a merchant cart configuration map module. Such a module may map the shopping cart information into a merchant server's shopping cart process.

In an embodiment, an order streaming system, implemented in a client-server system, can be configured to allow a standardized e-commerce digital shopping cart to submit and complete transaction orders with any necessary information and steps for completing the transaction order into two or more distinct e-commerce systems. This may be done by communicating with the order streaming system, where the order streaming system is configured to simulate a browser experience of 1) filling out data in fields, 2) business transaction processing steps, and 3) any necessary responses for each e-commerce system that the order streaming system has mapped. The transaction order into these two or more distinct e-commerce systems occurs through the order proxy system. Additionally, the order proxy system may have a merchant cart configuration map module to map the shopping cart information from the standard e-commerce digital shopping cart into the specific e-commerce's merchant server's shopping cart process from the two or more distinct e-commerce systems.

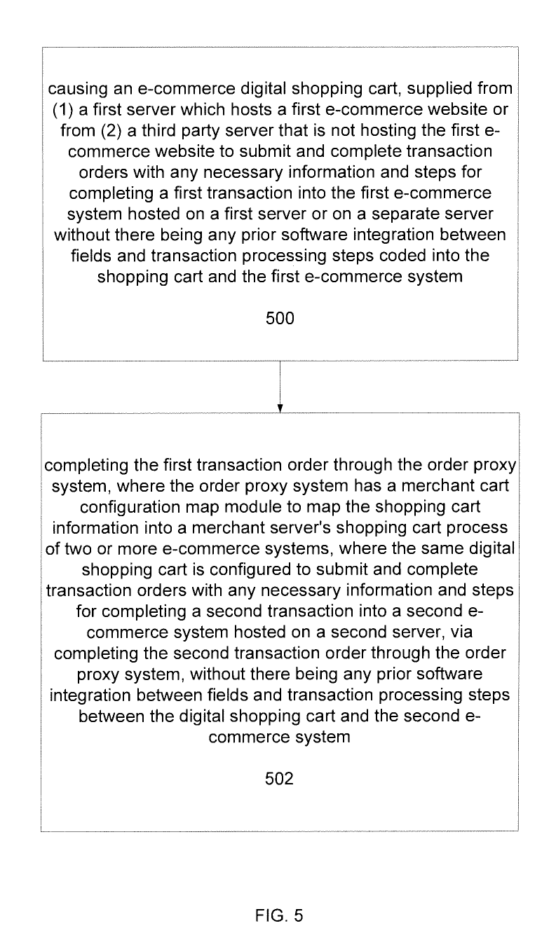

FIG. 5 illustrates an example method for a client—server system in accordance with an embodiment. In step 500, an example method can cause an e-commerce digital shopping cart, supplied from (1) a first server which hosts a first e-commerce website or from (2) a third party server that is not hosting the first e-commerce website to submit and complete transaction orders. These orders may be completed with any necessary information and steps for completing a first transaction into the first e-commerce system hosted on the first server or on a separate server without there being any prior software integration between fields and transaction processing steps coded into the shopping cart and the first e-commerce system.

In step 502, the example method can complete the first transaction order through the order proxy system The order proxy system may have a merchant cart configuration map module to map the shopping cart information into a merchant server's shopping cart process of two or more e-commerce systems. Additionally, the same digital shopping cart may be configured to submit and complete transaction orders with any necessary information and steps for completing a second transaction into a second e-commerce system hosted on a second server. The second transaction order can be completed through the order proxy system, without there being any prior software integration between fields and transaction processing steps between the digital shopping cart and the second e-commerce system.

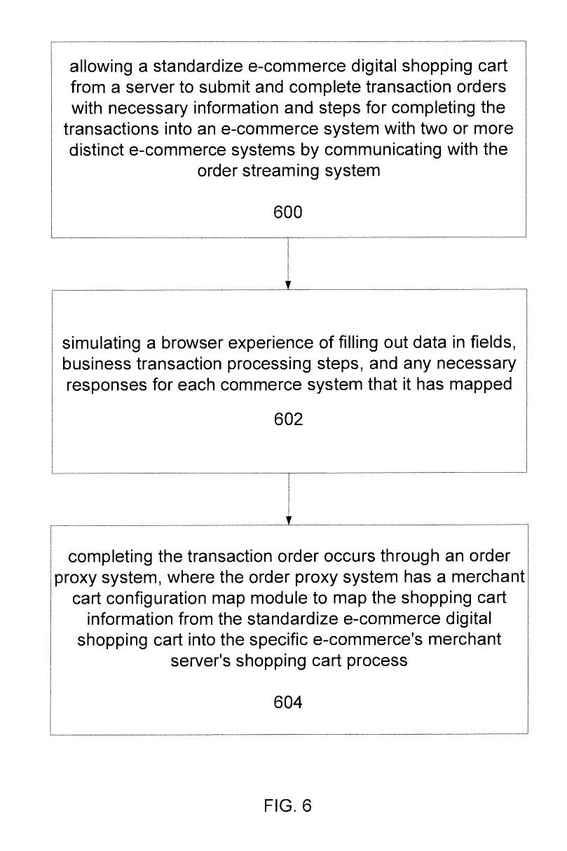

In an embodiment, an example method, such as one of the example methods illustrated in FIG. 5, above, or FIG. 6, discussed below, may further include a mapping process that includes authentication, account creation, cart session, cart items, cart options, cart checkout, validation, payment process and order confirmation. After mapping the shopping cart information to the merchant's shopping cart configuration, the order proxy system may then be able to transmit the order through the merchant's shopping cart process and into the merchant's e-commerce system and database.

In an embodiment, the transmission of an order through the order proxy system results in two-way communication with the merchant's e-commerce system and the proxy system; and the proxy system and the client machine. Additionally, an order rejection or confirmation response from the merchant's e-commerce system can be routed through the order proxy system to be displayed to the user who originated the order in the client web browser. An embodiment can further include routing from a client web browser into an order processing system, where an order proxy process is one processing option.

An embodiment can include providing a web bot configured to go out and re-verify the mapping process in libraries to check if a map of the merchant's ordering process needs to be updated and providing a database with a library of retailer maps. Some examples receive an inbound shopping cart communication and direct them to order processing service. Additionally, an order proxy block does all the mapping and injecting of data and fulfillment of business logic steps. In an embodiment a web browser ordering experience can be simulated, for example, directly injecting an ordering system in one injection step.

FIG. 6 illustrates another example method for a client—server system in accordance with an embodiment. In step 600, an example method can allow a standardized e-commerce digital shopping cart to submit and complete transaction orders. Such a method can include necessary information and steps for completing the transactions into two or more distinct e-commerce systems. For example, some e-commerce systems might be made up of two, three, four, five, or more distinct e-commerce systems. This may be done by communicating with the order streaming system.

In step 602, the example method can simulate a browser experience of filling out data in fields, business transaction processing steps, and any necessary responses for each commerce system that it has mapped.

In step 604, the example method can complete a transaction order that occurs through an order proxy system. The order proxy system used may, for example, have a merchant cart configuration map module. In some examples, such a module maps shopping cart information from a standardized e-commerce digital shopping cart into a specific e-commerce's merchant server's shopping cart process.

In an embodiment, an example method, such as one of the example methods illustrated in FIG. 5 or 6 may further include (1) extracting information from the shopping cart, (2) providing a proxy system that stands in as a proxy during a simulative web browsing experience as the proxy system injects data into the fields to populate those fields of an e-commerce ordering process, (3) gives any necessary responses to advance an order process and relays notices to a user on the client machine filling out the shopping cart, and wherein the proxy system is a middle man for a universal standardized shopping cart that has a library of mapped out online shopping process for an e-commerce merchant.

Example methods can also use a web crawler or a web bot mechanism to collect the fields and business logic steps that scripts of a merchants ordering process require. Additionally, order process steps may include manual verification of orders and receiving the fields and business logic steps and responses needed form systems implementing the method. Further, mapping and automating of an example system inside the proxy system may be performed.

In an embodiment, an example method may also include (1) standardizing a shopping experience for an end user of a client, wherein a same template of the digital shopping cart is utilized in one shopping cart for tens, hundreds, or thousands of e-commerce ordering processes. Steps of filling in billing information and item information may be asynchronous and serialized. Additionally, the mapping may capture these business logic steps. Further, the proxy system may directly talk to and push data and steps to the order system of a retailer.

In an embodiment, an example method may present fields and icons to take details of desired information to assist people making purchases online and reside in a client web browser on a client machine. Additionally, a transaction order from the client web browser can be initiated and the client web browser can be directed to pass an order into the order proxy system. The example method may also communicate through the Internet with the merchant's shopping cart in order to map the merchant's shopping cart configuration. Mapping the shopping cart information into the merchant server's shopping cart process can also be provided.

In an embodiment, the following steps may be coded to occur in the shopping cart and in an order proxy server: (1) the e-commerce digital shopping carts can have code scripted to present fields and icons to take details of desired information to assist people making purchases online and reside in a client web browser on a client machine, (2) a user of the client machine may initiate a transaction order from the client web browser, (3) the shopping cart can be coded to direct the client web browser to pass an order into the order proxy system, (4) the system communicates through the Internet with the merchant's shopping cart in order to map the merchant's shopping cart configuration, and (5) wherein the order proxy server has a merchant cart configuration map module to map the shopping cart information into the merchant server's shopping cart process.

Various methods and apparatus include an order streaming system. Such a system can be configured to allow a standardized e-commerce digital shopping cart to submit and complete transaction orders with necessary information and steps for completing the transactions into an e-commerce system with multiple distinct e-commerce systems by communicating with the order streaming system.

In an embodiment the order streaming system on a server may simulate a browser experience of filling out data in fields, business transaction processing steps, and any necessary responses for each commerce system that it has mapped. Additionally, completing the transaction order can occur through an order proxy system. For example, the order proxy system can have a merchant cart configuration map module to map the shopping cart information from the standard e-commerce digital shopping cart into the specific e-commerce's merchant server's shopping cart process.

FIG. 1 illustrates a block diagram of an example computer system that may use an embodiment of one or more of the software applications discussed herein. The computing system environment 100 is only one example of a suitable computing environment and is not intended to suggest any limitation as to the scope of use or functionality of an embodiment. Neither should the computing environment 100 be interpreted as having any dependency or requirement relating to any one or combination of components illustrated in the exemplary operating environment 100.

An embodiment may be operational with numerous other general purpose or special purpose computing system environments or configurations. Examples of well known computing systems, environments, and/or configurations that may be suitable for use with an embodiment include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

An embodiment may be described in the general context of computing device executable instructions, such as program modules, being executed by a computer. Generally, program modules include routines, programs, objects, components, data structures, etc. that performs particular tasks or implement particular abstract data types. Those skilled in the art can implement the description and/or figures herein as computer-executable instructions, which can be embodied on any form of computer readable media discussed below.

An embodiment may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary computing type system for implementing an embodiment includes a general-purpose computing device in the form of a computer 110. Components of computer 110 may include, but are not limited to, a processing unit 120 having one or more processing cores, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable mediums uses include storage of information such as computer readable instructions, data structures, program modules or other data. Computer readable mediums include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computing device such as computer 100. Communication media typically embodies computer readable instructions, data structures, program modules, or other transport mechanism and includes any information delivery media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, USB drives and devices, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet. A browser application may be resident on the computing device and stored in the memory.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

It should be noted that an embodiment can be carried out on a computer system such as that described with respect to FIG. 1. However, an embodiment can be carried out on a server, a computer devoted to message handling, or on a distributed system in which different portions of an embodiment are carried out on different parts of the distributed computing system.

Another device that may be coupled to bus 111 is a power supply such as a battery and Alternating Current adapter circuit. As discussed above, the DC power supply may be a battery, a fuel cell, or similar DC power source needs to be recharged on a periodic basis. The wireless communication module 172 may employ a Wireless Application Protocol to establish a wireless communication channel. The wireless communication module 172 may implement a wireless networking standard such as Institute of Electrical and Electronics Engineers (IEEE) 802.11 standard, IEEE std. 802.11-1999, published by IEEE in 1999.

Examples of mobile computing devices may be a laptop computer, a cell phone, a personal digital assistant, or other similar device with on board processing power and wireless communications ability that is powered by a Direct Current (DC) power source that supplies DC voltage to the mobile device and that is solely within the mobile computing device and needs to be recharged on a periodic basis, such as a fuel cell or a battery.

Referring back to FIG. 2, FIG. 2 illustrates a network environment 200 in which the techniques described may be applied. The network environment 200 has a network 202 that connects S servers 204-1 through 204-S, and C clients 208-1 through 208-C. As shown, several systems in the form of S servers 204-1 through 204-S and C clients 208-1 through 208-C are connected to each other via a network 202, which may be, for example, an on-chip communication network. Note that alternatively the network 202 might be or include one or more of: inter-chip communications, an optical network, the Internet, a Local Area Network (LAN), Wide Area Network (WAN), satellite link, fiber network, cable network, or a combination of these and/or others. The servers may represent, for example: a master device on a chip; a memory; an intellectual property core, such as a microprocessor, communications interface, etc.; a disk storage system; and/or computing resources. Likewise, the clients may have computing, storage, and viewing capabilities. The method and apparatus described herein may be applied to essentially any type of communicating means or device whether local or remote, such as a LAN, a WAN, a system bus, on-chip bus, etc. It is to be further appreciated that the use of the term client and server is for clarity in specifying who initiates a communication (the client) and who responds (the server). No hierarchy is implied unless explicitly stated. Both functions may be in a single communicating device, in which case the client-server and server-client relationship may be viewed as peer-to-peer. Thus, if two devices such as 208-1 and 204-S can both initiate and respond to communications, their communication may be viewed as peer-to-peer. Likewise, communications between 204-1 and 204-S, and 208-1 and 208-C may be viewed as peer-to-peer if each such communicating device is capable of initiation and response to communication.

FIG. 2 also illustrates a block diagram of an embodiment of a server to display the application on a portion of a media space, such as a web page, a profile page on a social network site, etc. The application may be embedded into a third party's media space, such as an HTML web page, a page of a social network platform, etc. The application when executed on a server 204 causes the server 204 to display windows and user interface screens on a portion of a media space such as a web page. A user from a client machine 208 may interact with the page that contains the embedded application, and then supply input to the query/fields and/or service presented by a user interface of the application. The web page may be served by a web server 204 on any HTML or WAP enabled client device 208 or any equivalent thereof such as a mobile device or personal computer. The client device 208 may host a browser to interaction with the server. The application has code scripted to present fields and icons to take details of desired information. The intelligent application may be implemented as a viral web application hosted on the server and served to the browser of client machine 208 of the customer. The intelligent application then serves pages that allow entry of details and further pages that allow entry of more details.

An embodiment can include various routines that might include software, hardware logic, or a combination of both. Additionally, the software portions may by executed by a computing device and stored using, for example, a computing device storage medium. For example, a portable application and other scripted in code components may be stored on a computer readable medium which when executed on the server causes the server to display the application on a portion of a media space. The media space may be web pages, social network platforms, etc. hosted on a server.

In an embodiment, the software used to facilitate the functions and processes described herein can be embodied onto a machine-readable medium. A machine-readable medium includes any mechanism that provides (e.g., stores and/or transmits) information in a form readable by a machine (e.g., a computer). For example, a machine-readable medium includes read only memory (ROM); random access memory (RAM); magnetic disk storage media; optical storage media; flash memory devices; DVD's, EPROMs, EEPROMs, FLASH, magnetic or optical cards, or any type of media suitable for storing electronic instructions. The information representing the apparatuses and/or methods stored on the machine-readable medium may be used in the process of creating the apparatuses and/or methods described herein. Algorithms, procedures, routines, or programs as described herein in this application may also be included as variants of the portable application and security mechanism.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These routines, algorithms, etc. may be written in a number of different programming languages. Also, an algorithm may be implemented with lines of code in software, configured logic gates in software, or a combination of both. The portable application and its security mechanisms may be scripted in any number of software program languages.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

While some specific embodiments of the invention have been shown, the invention is not to be limited to these embodiments. The invention is to be understood as not limited by the specific embodiments described herein, but only by scope of the appended claims. The additional documents include other aspects of an embodiment.

What is claimed is:

1. An apparatus, comprising:
an order proxy system implemented in a client-server system, configured to allow an e-commerce digital shopping cart, supplied from (1) a first server which hosts a first e-commerce website or from (2) a third party server that is not hosting the first e-commerce website, to submit and complete transaction orders with any necessary information and steps for completing a first transaction into the first e-commerce system hosted on the first server without there being any prior software integration between fields and transaction processing steps coded into the digital shopping cart and the first e-commerce system, via completing a first transaction order through the order proxy system, where the order proxy system has a merchant cart configuration map module to map the shopping cart information into a merchant server's shopping cart process of two or more e-commerce systems, where the same digital shopping cart is configured to submit and complete transaction orders with any necessary information and steps for completing a second transaction into a second e-commerce system hosted on a second server, via completing the second transaction order through the order proxy system, without there being any prior software integration between fields and transaction processing steps between the digital shopping cart and the second e-commerce system.

2. The apparatus of claim 1, wherein
the proxy system is a middle man for a universal standard shopping cart that has a library of mapped out online shopping process for an e-commerce merchant, the proxy system may be implemented in software, hardware logic or a combination of both, and the portions implemented in software are executable by a computing device and stored on computer readable medium;
the proxy system extracts information from the digital shopping cart, stands in as a proxy during a simulative web browsing experience as the proxy system injects data into the fields to populate those fields of the merchant server's shopping cart ordering process, gives any necessary responses to advance the order process and relays notices to a user on the client machine filling out the shopping cart, and wherein the proxy system uses an intelligent data collection mechanism, including a web crawler or a web bot, to collect the fields and business logic steps that scripts of the merchant's shopping cart ordering process require;
the ordering process steps are manually verified after the intelligent data collection mechanism collected the fields and business logic steps required to ensure an accuracy of the mapped out fields and business logic step for the particular merchant's shopping cart ordering process; and
wherein, once the fields and business logic steps and responses needed are received and manually verified for accuracy, then the system is mapped and automated in the proxy system.

3. The apparatus of claim 1, wherein the apparatus standardizes a shopping experience for an end user of the client machine;
wherein a same template of the digital shopping cart is utilized by the client machine as a single shopping cart configured to used for tens, hundreds, or thousands of e-commerce ordering processes hosted on different servers;
wherein steps of filling in billing information and item information are asynchronous and serialized;
wherein the mapping captures these business logic steps;
wherein the proxy system directly talks to and pushes data and steps to the order system of a retailer and where a transaction order can be routed from a client web browser into an order processing system, where an order proxy process is one processing option;
wherein a web bot is configured to go out and re-verify the mapping process in libraries to check if a map of the merchant's ordering process needs to be updated in a database with a library of retailer maps;
wherein a gateway service receives inbound shopping cart communications and directs them to order processing service;
wherein an order proxy block does all the mapping and injecting of data and fulfillment of business logic steps;
wherein a web browser ordering experience is simulated; and
wherein partners using the order proxy service that have integrated their system with the order proxy service and the data extracted from the shopping cart is directly injected into their ordering system in one injection step.

4. The apparatus of claim 2, wherein
the universal standard digital shopping cart has code scripted to present fields and icons to take details of desired information to assist people making purchases online and residing in a client web browser on a client machine, the code implemented in software, hardware logic, or a combination of both;
the proxy order system is configured to receive a transaction order from the client web browser of the client machine;
the shopping cart is coded to direct the client web browser to pass an order into the order proxy system, which the system communicates through the Internet with the merchant's shopping cart in order to map the merchant's shopping cart configuration, where the shopping cart is coded in software, hardware logic, or a combination of both;
wherein the order proxy server has a merchant cart configuration map module to map the shopping cart information into the merchant server's shopping cart process;
wherein the mapping process includes authentication, account creation, cart session, cart items, cart options, cart checkout, validation, payment process and order confirmation;
after mapping the shopping cart information to the merchant's shopping cart configuration, the order proxy system then transmits the order through the merchant's shopping cart process and into the merchant's e-commerce system and database;
wherein the transmission of an order through the order proxy system results in two-way communication with the merchant's e-commerce system and the proxy system, and the proxy system and the client machine; and
wherein an order rejection or confirmation response from the merchant's e-commerce system would be routed through the order proxy system to be displayed to the user who originated the order in the client web browser.

5. A method for a client-server system, comprising:
causing an e-commerce digital shopping cart, supplied from (1) a first server which hosts a first e-commerce website or from (2) a third party server that is not hosting the first e-commerce website to submit and complete transaction orders with any necessary information and steps for completing a first transaction into the first e-commerce system hosted on the first server or on a separate server without there being any prior software integration between fields and transaction processing steps coded into the shopping cart and the first e-commerce system; and
completing the first transaction order through the order proxy system, where the order proxy system has a merchant cart configuration map module to map the shopping cart information into a merchant server's shopping cart process of two or more e-commerce systems, where the same digital shopping cart is configured to submit and complete transaction orders with any necessary information and steps for completing a second transaction into a second e-commerce system hosted on a second server, via completing the second transaction order through the order proxy system, without there being any prior software integration between fields and transaction processing steps between the digital shopping cart and the second e-commerce system.

6. The method of claim 5, further comprising:
using a web crawler or a web bot mechanism on the server to collect the fields and business logic steps that scripts of a merchants ordering process require;
manually verifying the ordering process steps;
receiving the fields and business logic steps and responses needed;
mapping and automating the system inside the proxy system;
extracting information from the shopping cart;
providing a proxy system that stands in as a proxy during a simulative web browsing experience as the proxy system injects data into the fields to populate those fields of an e-commerce ordering process, gives any necessary responses to advance an order process and relays notices to a user on the client machine filling out the shopping cart;
wherein the proxy system is a middle man for a universal standard shopping cart that has a library of mapped out online shopping process for an e-commerce merchant; and
where the universal digital shopping cart is supplied either from the server hosting the e-commerce site or a third party server, and the universal digital shopping cart is configured to submit and complete transaction orders with any necessary information and steps for completing a transaction on two or more different e-commerce systems.

7. The method of claim 5, further comprising:
standardizing a shopping experience for an end user of a client, wherein a same template of the digital shopping cart is utilized in one shopping cart for tens, hundreds, or thousands of e-commerce ordering processes;
wherein steps of filling in billing information and item information are asynchronous and serialized;
wherein the mapping captures these business logic steps;
wherein the proxy system directly talks to and pushes data and steps to the order system of a retailer;
presenting fields and icons to take details of desired information to assist people making purchases online and residing in a client web browser on a client machine;
initiating a transaction order from the client web browser;
directing the client web browser to pass an order into the order proxy system;
communicating through the Internet with the merchant's shopping cart in order to map the merchant's shopping cart configuration; and
mapping the shopping cart information into the merchant server's shopping cart process.

8. The method of claim 7, wherein the mapping process includes authentication, account creation, cart session, cart items, cart options, cart checkout, validation, payment process and order confirmation; and
after mapping the shopping cart information to the merchant's shopping cart configuration, the order proxy system then transmits the order through the merchant's shopping cart process and into the merchant's e-commerce system and database.

9. The method of claim 8, wherein the transmission of an order through the order proxy system results in two-way communication with the merchant's e-commerce system and the proxy system, and the proxy system and the client machine; and
wherein an order rejection or confirmation response from the merchant's e-commerce system would be routed through the order proxy system to be displayed to the user who originated the order in the client web browser.

10. The method of claim 7, further comprising:
routing from a client web browser into an order processing system, where an order proxy process is one processing option;
providing a web bot on the server configured to go out and re-verify the mapping process in libraries to check if a map of the merchant's ordering process needs to be updated;
receiving an inbound shopping cart communications and directs them to order processing service; wherein an order proxy block does all the mapping and injecting of data and fulfillment of business logic steps;
simulating a web browser ordering experience; and
directly injecting data required for a transaction order of an ordering system in one injection step.

11. An apparatus, comprising:
an order streaming system, implemented in a client-server system, configured to allow a standardized e-commerce digital shopping cart to submit and complete transaction orders with any necessary information and steps for completing the transaction order into two or more distinct e-commerce systems by communicating with the order streaming system, where the order streaming system is configured to simulate a browser experience of 1) filling out data in fields, 2) business transaction processing steps, and 3) any necessary responses for each e-commerce system that the order streaming system has mapped, where the transaction order into these two or more distinct e-commerce systems occurs through the order proxy system, where the order proxy system has a merchant cart configuration map module to map the shopping cart information from the standard e-commerce digital shopping cart into the specific e-commerce's merchant server's shopping cart process from the two or more distinct e-commerce systems, where the order streaming system is implemented in software, hardware, or a combination of both, and any portions implemented in software are executable by a computing device and stored on a computer readable medium.

12. The apparatus of claim 11, wherein the proxy system is a middle man for a universal standard shopping cart that has a library of mapped out online shopping process for an e-commerce merchant, the proxy system implemented in software portions that are executable by a computing device and stored on a computer readable medium;
the proxy system extracts information from the shopping cart, stands in as a proxy during a simulative web browsing experience as the proxy system injects data into the fields to populate those fields of an e-commerce ordering process, gives any necessary responses to advance an order process and relays notices to a user on the client machine filling out the shopping cart and wherein the proxy system uses a web crawler or a web bot mechanism to collect the fields and business logic steps that scripts a merchants ordering process require;
wherein the ordering process steps are manually verified; and
wherein, once the fields and business logic steps and responses needed are received, then the system is mapped and automated in the proxy system.

13. The apparatus of claim 11, wherein the apparatus standardizes a shopping experience for an end user of a client;
wherein a same template of the digital shopping cart is utilized in one shopping cart for tens, hundreds, or thousands of e-commerce ordering processes;
wherein steps of filling in billing information and item information are asynchronous and serialized;
wherein the mapping captures these business logic steps;
wherein the proxy system directly talks to and pushes data and steps to the order system of a retailer and where a transaction order can be routed from a client web browser into an order processing system, where an order proxy process is one processing option;
further comprising a web bot configured to go out and re-verify the mapping process in libraries to check if a map of the merchant's ordering process needs to be updated and a database with a library of retailer maps;
wherein a gateway service receives inbound shopping cart communications and directs them to order processing service;
wherein an order proxy block does all the mapping and injecting of data and fulfillment of business logic steps;
wherein a web browser ordering experience is simulated; and
wherein partners using the order proxy service that have integrated their system with the order proxy service and the data extracted from the shopping cart are directly injected into their ordering system in one injection step.

14. The apparatus of claim 11, wherein
the e-commerce digital shopping carts have code scripted to present fields and icons to take details of desired information to assist people making purchases online and residing in a client web browser on a client machine, the code implemented in software, hardware logic, or a combination of both;
a user of the client machine can initiate a transaction order from the client web browser;
the shopping cart is coded in software, hardware logic, or a combination of both to direct the client web browser to pass an order into the order proxy system, which the system communicates through the Internet with the merchant's shopping cart in order to map the merchant's shopping cart configuration;
wherein the order proxy server has a merchant cart configuration map module to map the shopping cart information into the merchant server's shopping cart process;
wherein the mapping process includes authentication, account creation, cart session, cart items, cart options, cart checkout, validation, payment process and order confirmation;
after mapping the shopping cart information to the merchant's shopping cart configuration, the order proxy system then transmits the order through the merchant's shopping cart process and into the merchant's e-commerce system and database;
wherein the transmission of an order through the order proxy system results in two-way communication with the merchant's e-commerce system and the proxy system, and the proxy system and the client machine; and
wherein an order rejection or confirmation response from the merchant's e-commerce system would be routed through the order proxy system to be displayed to the user who originated the order in the client web browser.

15. A method for order streaming on a client-server system, comprising:
allowing a standard e-commerce digital shopping cart from a server to submit and complete transaction orders with necessary information and steps for completing the transactions into two or more distinct e-commerce systems by communicating with the order streaming system;
simulating a browser experience of filling out data in fields, business transaction processing steps, and any necessary responses for each commerce system that it has mapped, and
completing the transaction order occurs through an order proxy system, where the order proxy system has a merchant cart configuration map module to map the shopping cart information from the standard e-commerce digital shopping cart into the specific e-commerce's merchant server's shopping cart process.

16. The method of claim 15, further comprising:
using a web crawler or a web bot mechanism on the server to collect the fields and business logic steps that scripts of a merchants ordering process require;
manually verifying the ordering process steps;
receiving the fields and business logic steps and responses needed;
mapping and automating the system inside the proxy system;
extracting information from the shopping cart;
providing a proxy system that stands in as a proxy during a simulative web browsing experience as the proxy system injects data into the fields to populate those fields of an e-commerce ordering process, gives any necessary responses to advance an order process and relays notices to a user on the client machine filling out the shopping cart; and
wherein the proxy system is a middle man for a universal standard shopping cart that has a library of mapped out online shopping process for an e-commerce merchant.

17. The method of claim 15, further comprising:
standardizing a shopping experience for an end user of a client, wherein a same template of the digital shopping cart is utilized in one shopping cart for tens, hundreds, or thousands of e-commerce ordering processes;
wherein steps of filling in billing information and item information are asynchronous and serialized;
wherein the mapping captures these business logic steps;
wherein the proxy system directly talks to and pushes data and steps to the order system of a retailer;
presenting fields and icons to take details of desired information to assist people making purchases online and residing in a client web browser on a client machine;
initiating a transaction order from the client web browser;
directing the client web browser to pass an order into the order proxy system;
communicating through the Internet with the merchant's shopping cart in order to map the merchant's shopping cart configuration; and
mapping the shopping cart information into the merchant server's shopping cart process.

18. The method of claim 17, wherein the mapping process includes authentication, account creation, cart session, cart items, cart options, cart checkout, validation, payment process and order confirmation; and
after mapping the shopping cart information to the merchant's shopping cart configuration, the order proxy system then transmits the order through the merchant's shopping cart process and into the merchant's e-commerce system and database.

19. The method of claim 18, wherein the transmission of an order through the order proxy system results in two-way communication with the merchant's e-commerce system and the proxy system, and the proxy system and the client machine; and
wherein an order rejection or confirmation response from the merchant's e-commerce system would be routed through the order proxy system to be displayed to the user who originated the order in the client web browser.

20. The method of claim 17, further comprising routing from a client web browser into an order processing system, where an order proxy process is one processing option;
providing a web bot on the server configured to go out and re-verify the mapping process in libraries to check if a map of the merchant's ordering process needs to be updated;
receiving an inbound shopping cart communications and directs them to order processing service; wherein an order proxy block does all the mapping and injecting of data and fulfillment of business logic steps;
simulating a web browser ordering experience is; and
directly injecting data required for a transaction order of an ordering system in one injection step.
